(19) United States
(12) Patent Application Publication
(10) Pub. No.: US 2023/0306393 A1
(43) Pub. Date: Sep. 28, 2023

(54) SYSTEMS AND METHODS FOR INTEGRATING PAY BY BANK SERVICES

(71) Applicant: JPMORGAN CHASE BANK, N.A., New York, NY (US)

(72) Inventors: Jamie Scott BERNIKER, Florham Park, NJ (US); Jeremy D. Wimmer, Pound Ridge, NY (US)

(21) Appl. No.: 18/188,801

(22) Filed: Mar. 23, 2023

Related U.S. Application Data
(60) Provisional application No. 63/269,834, filed on Mar. 23, 2022.

(51) Int. Cl. G06Q 20/10; G06Q 20/36; G06Q 20/38; G06Q 20/02

(52) U.S. Cl. CPC G06Q 20/108; G06Q 20/3678; G06Q 20/3821; G06Q 20/023; G06Q 2220/00

(57) ABSTRACT

Systems and methods for integrating pay by bank services are disclosed. A method may include a merchant computer program: (1) receiving a request to add funds to a merchant account or wallet; (2) receiving a selection to add an online banking account to the merchant account or wallet; (3) receiving a selection of a funding amount; (4) receiving a selection of a user financial institution; (5) receiving user login credentials for the user financial institution; (6) receiving, from a user financial institution backend, one or more bank accounts associated with the user login credentials; (7) receiving a selection of one of the bank accounts; (8) receiving a token for the selected bank account from a merchant financial institution backend; (9) storing the token in a merchant wallet; and (10) conducting a funding transaction for the funding amount using the token.

### RELATED APPLICATIONS

This application claims priority to, and the benefit of, U.S. Provisional Patent Application Ser. No. 63/269,834, filed Mar. 23, 2022, the disclosure of which is hereby incorporated, by reference, in its entirety.

### BACKGROUND OF THE INVENTION

### 1. Field of the Invention

Systems and methods for integrating pay by bank services are disclosed.

### 2. Description of the Related Art

It is commonplace to pay online merchants with credit cards. Online merchants often save payment instruments, such as credit cards and debit cards. Some even offer third party payment providers, such as PayPal or Venmo.

### SUMMARY OF THE INVENTION

Systems and methods for integrating pay by bank services are disclosed. In one embodiment, a method for pay by bank services may include: (1) receiving, at a merchant computer program for a merchant executed on a user electronic device, a request to add funds to a merchant account or wallet; (2) receiving, at the merchant computer program, a selection to add an online banking account to the merchant account or wallet; (3) receiving, at the merchant computer program, a selection of a funding amount; (4) receiving, at the merchant computer program, a selection of a user financial institution; (5) receiving, at the merchant computer program, user login credentials for the user financial institution; (6) receiving, at the merchant computer program and from a user financial institution backend, one or more bank accounts associated with the user login credentials; (7) receiving, at the merchant computer program, a selection of one of the bank accounts; (8) receiving, at the merchant computer program, a token for the selected bank account from a merchant financial institution backend; (9) storing, by the merchant computer program, the token in a merchant wallet; and (10) conducting, by the merchant computer program, a funding transaction for the funding amount using the token.

In one embodiment, the request to add funds to the merchant account or wallet, the selection to add the online banking account to the merchant account or wallet, the selection of the funding amount, and the selection of the user financial institution may be received in a merchant user interface in a browser or application.

In one embodiment, the user login credentials may include a username and password and/or a token.

In one embodiment, the one or more bank accounts associated with the user login credentials may be presented in a lightbox or an iFrame.

In one embodiment, the merchant financial institution backend may be configured to generate the token for the selected bank account by generating a unique identifier for the selected bank account, associating the unique identifier with the selected bank account, and storing the association between the unique identifier and the selected bank account.

In one embodiment, wherein the token may be limited to use with the merchant, may be restricted to a number of uses, may be restricted to a dollar amount, etc.

In one embodiment, the funding transaction may include an automated clearing house (ACH) transaction.

In one embodiment, the merchant financial institution backend may be configured to optimize a payment route for the funding transaction.

According to another embodiment, a system may include: a user electronic device executing a merchant computer program; a user financial institution backend executing a user financial institution computer program and in communication with an account database; a merchant backend for a merchant executing a merchant computer program and in communication with a merchant wallet; a merchant financial institution backend executing a merchant financial institution computer program and in communication with a vault; and a payment network. The merchant computer program receives a request to add funds to a merchant account or wallet, receives a selection to add an online banking account to the merchant account or wallet; receives a selection of a funding amount; receives a selection of a user financial institution; and receives user login credentials for the user financial institution. The user financial institution computer program authenticates the user using the user login credential and retrieves one or more bank accounts associated with the user login credentials and communicates the one or more bank accounts to the merchant computer program. The merchant computer program receives a selection of one of the bank accounts. The user financial institution computer program communicates the selected bank account to the merchant financial institution computer program. The merchant financial institution computer program generates a token comprising a unique identifier for the selected bank account and stores the association in the vault; receives the token for the selected bank account from the merchant financial institution computer program; stores the token in a merchant wallet; and conducts a funding transaction for the funding amount using the token over the payment network.

In one embodiment, the request to add funds to the merchant account or wallet, the selection to add the online banking account to the merchant account or wallet, the selection of the funding amount, and the selection of the user financial institution may be received in a merchant user interface in a browser or application.

In one embodiment, the user login credentials may include a username and password and/or a token.

In one embodiment, the one or more bank accounts associated with the user login credentials may be presented in a lightbox or an iFrame.

In one embodiment, wherein the token may be limited to use with the merchant, may be restricted to a number of uses, may be restricted to a dollar amount, etc.

In one embodiment, the funding transaction may include an automated clearing house (ACH) transaction.

In one embodiment, the merchant financial institution backend may optimize a payment route for the funding transaction.

According to another embodiment, a non-transitory computer readable storage medium may include instructions stored thereon which when read and executed by one or more computer processors, cause the one or more computer processors to perform steps comprising: receiving a request to add funds to a merchant account or wallet; receiving a selection to add an online banking account to the merchant account or wallet; receiving a selection of a funding amount; receiving a selection of a user financial institution; receiving user login credentials for the user financial institution; receiving, from a user financial institution backend, one or more bank accounts associated with the user login credentials; receiving a selection of one of the bank accounts; receiving a token for the selected bank account; storing the token in a merchant wallet; and conducting a funding transaction for the funding amount using the token.

According to another embodiment, a method may include (1) receiving, at a merchant computer program for a merchant executed on a user electronic device, a request to add funds to a merchant account or wallet; (2) receiving, at the merchant computer program, a selection to add an online banking account to the merchant account or wallet; (3) receiving, at the merchant computer program, a selection of a funding amount; (4) receiving, at the merchant computer program, a selection of a financial institution; (5) receiving, at the merchant computer program, user login credentials for the financial institution; (6) receiving, at the merchant computer program and from a financial institution backend, one or more bank accounts associated with the user login credentials; (7) receiving, at the merchant computer program, a selection of one of the bank accounts; (8) receiving, at the merchant computer program, a token for the selected bank account; (9) storing, by the merchant computer program, the token in a merchant wallet; and (10) conducting, by the merchant computer program, a funding transaction for the funding amount using the token.

In one embodiment, the request to add funds to the merchant account or wallet, the selection to add the online banking account to the merchant account or wallet, the selection of the funding amount, and the selection of the financial institution may be received in a merchant user interface in a browser or application.

In one embodiment, the user login credentials may include a username and password and/or a token.

In one embodiment, the one or more bank accounts associated with the user login credentials may be presented in a lightbox or an iFrame.

In one embodiment, the financial institution backend may be configured to generate the token for the selected bank account by generating a unique identifier for the selected bank account, associating the unique identifier with the selected bank account, and storing the association between the unique identifier and the selected bank account.

In one embodiment, the token is limited to use with the merchant.

In one embodiment, the token may be restricted to a number of uses.

In one embodiment, the token may be restricted to a dollar amount.

In one embodiment, the funding transaction may include an automated clearing house (ACH) transaction.

In one embodiment, the financial institution backend may be configured to optimize a payment route for the funding transaction.

According to another embodiment, a system may include a user electronic device executing a merchant computer program; a financial institution backend executing a financial institution computer program and in communication with an account database and a vault; a merchant backend executing a merchant computer program and in communication with a merchant wallet; and a payment network. The merchant computer program receives a request to add funds to a merchant account or wallet, receives a selection to add an online banking account to the merchant account or wallet, receives a selection of a funding amount, receives a selection of a financial institution, and receives user login credentials for the financial institution. The financial institution computer program authenticates the user using the user login credentials and retrieves one or more bank accounts associated with the user login credentials and communicates the one or more bank accounts to the merchant computer program. The merchant computer program receives a selection of one of the bank accounts. The financial institution computer program generates a token comprising a unique identifier for the selected bank account and stores the association in the vault. The merchant computer program receives the token for the selected bank account from the financial institution computer program, stores the token in a merchant wallet, and conducts a funding transaction for the funding amount using the token over the payment network.

In one embodiment, the request to add funds to the merchant account or wallet, the selection to add the online banking account to the merchant account or wallet, the selection of the funding amount, and the selection of the financial institution may be received in a merchant user interface in a browser or application.

In one embodiment, the user login credentials may include a username and password and/or a token.

In one embodiment, the one or more bank accounts associated with the user login credentials may be presented in a lightbox or an iFrame.

In one embodiment, the token may be limited to use with the merchant, may be restricted to a number of uses, may be restricted to a dollar amount, etc.

In one embodiment, the funding transaction may include an automated clearing house (ACH) transaction.

In one embodiment, the financial institution backend may be configured to optimize a payment route for the funding transaction.

According to another embodiment, a non-transitory computer readable storage medium, including instructions stored thereon, which when read and executed by one or more computer processors, cause the one or more computer processors to perform steps comprising: receiving a request to add funds to a merchant account or wallet; receiving a selection to add an online banking account to the merchant account or wallet; receiving a selection of a funding amount; receiving a selection of a financial institution; receiving user login credentials for the financial institution; receiving, from a financial institution backend, one or more bank accounts associated with the user login credentials; receiving a selection of one of the bank accounts; receiving a token for the selected bank account; storing the token in a merchant wallet; and conducting a funding transaction for the funding amount using the token.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for integrating pay by bank services according to an embodiment;

FIG. 2 illustrates a method for integrating pay by bank services according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for integrating pay by bank services.

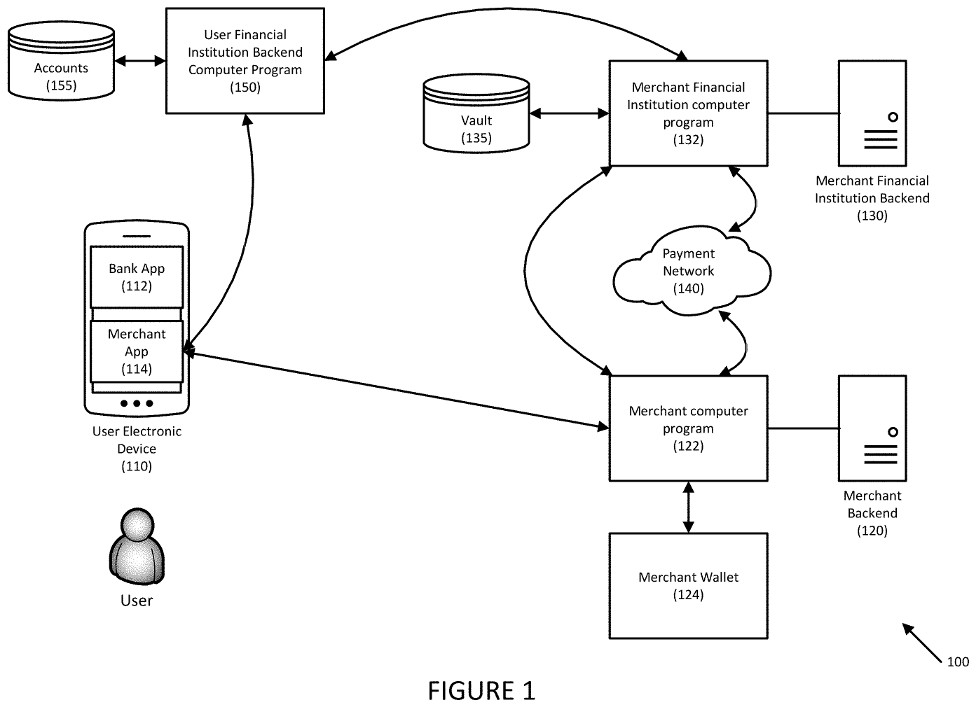

Referring to FIG. 1, a system for integrating pay by bank services is disclosed according to an embodiment. System 100 may include user electronic device 110, which may be any suitable electronic device including computers (e.g., workstations, desktops, laptops, notebooks, tablets, etc.), smart devices (e.g., smart phones, smart watches, etc.), Internet of Things (IoT) appliances, etc. User electronic device 110 may execute one or more computer programs or applications, including bank application (“app”) 112 and merchant app 114.

Merchant app 114 may interface with merchant computer program 122, which may provide online shopping services with a merchant. Merchant computer program may be executed by merchant backend 120, which may be a server (e.g., physical and/or cloud-based), computer, etc. Merchant computer program 122 may maintain, for each user, merchant account or wallet 124. Merchant account or wallet 124 may store provisioned payment instruments, such as credit cards, debit cards, etc., and may also store information for a demand deposit account (e.g., a checking account), a savings account, etc.

Merchant computer program 122 may also interface with merchant financial institution computer program 132 that may be executed by merchant financial institution backend 130. Merchant financial institution backend 130 may be a server, computer, etc.

In one embodiment, merchant computer program 122 may interface with merchant financial institution computer program 132 over any suitable communication network (e.g., the Internet).

User electronic device 110 may also execute bank app 112. Bank app 112 may be provided by a user financial institution and may interface with user financial institution computer program 150. This may provide a mechanism for user identity verification. For example, merchant app 114 may interface with bank app 112 to verify the user's identity.

User financial institution computer program 150 may also have access to account information for demand deposit accounts, savings accounts, etc. in user account database 155.

Merchant financial institution computer program 132 may receive user account information from user financial institution computer program 150, may tokenize the account number by creating a unique identifier (e.g., a payment token) for the bank account, and may store an association or mapping between the payment token and the bank account in, for example, vault 135. When a transaction involving a payment token is received, merchant financial institution computer program 132 may de-tokenize the payment token by looking up the bank account associated with or mapped to the payment token, and may conduct the transaction using the bank account over payment network 140.

Merchant computer program 122 may conduct a funding transaction using a payment token for the user. For example, the user may authorize a funding transaction to be conducted with a payment token. After de-tokenizing the payment token, merchant financial institution computer program 132 may process the transaction per any suitable process.

In one embodiment, the merchant may be associated with a financial institution that is separate from the user's financial institution. For example, the user may authenticate with its financial institution and may select a funding account from the accounts maintained by the user's financial institution. The merchant's financial institution may tokenize the user's account, store the association between the token and the user account in its vault, and may provide the token to the merchant.

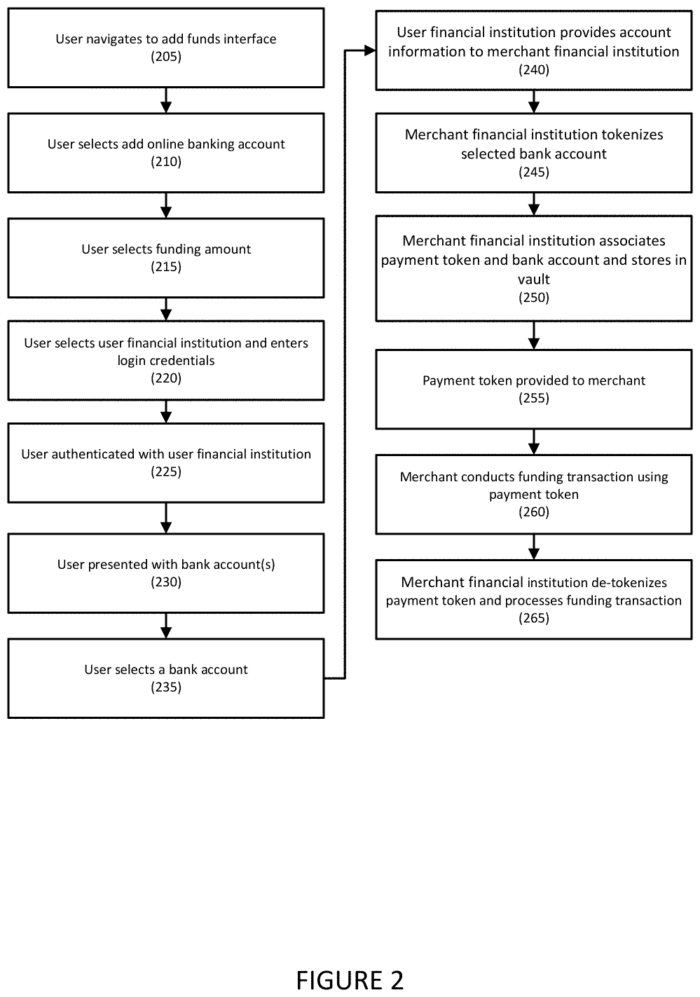

Referring to FIG. 2, a method for integrating pay by bank services is disclosed according to an embodiment.

In step 205, a user may navigate to an add funds interface for a merchant. The user may do this in a user interface presented in a merchant application or program executed by a user electronic device, by using a browser on the user electronic device, etc.

In step 210, the user may select an option to add an online banking account to a merchant account or wallet.

In step 215, the user may select a funding amount to fund a merchant account or wallet with. Any suitable manner of selecting a funding amount may be used as is necessary and/or desired, including entering the funding amount, selecting the funding amount option, selecting the funding amount from a drop-down menu, etc.

In step 220, the user may select a user financial institution for the funding account and may enter the user's login credentials. For example, the user may enter a username and password, may present a token, etc. For example, the merchant application may host screens for the financial institution, or may redirect the user to the financial institution log in page using, for example, an oAuth connection.

In step 225, the user may optionally be authenticated with the user financial institution using, for example, out-of-band authentication. For example, a registered SMS address, phone number, etc. may be sent a code and the user may enter the code in the merchant application or computer program. In another embodiment, a user financial institution application may provide a code that the user may enter into the merchant application or computer program, or may authenticate the user directly.

In step 230, once authenticated, the user may be presented with the bank account(s) associated with the login credentials. For example, a lightbox or iFrame may be used to present the bank account(s) to the user.

In step 235, the user may select one of the accounts as the funding account.

In step 240, if the user's financial institution is different from the merchant's financial institution, the user's financial institution may provide the user account information to the merchant's financial institution.

In step 245, the merchant financial institution backend for the merchant may tokenize the selected bank account. For example, the merchant financial institution backend may generate a unique identifier as a payment token for the selected bank account.

In one embodiment, the payment token may also be associated with certain limits or restrictions. For example, the payment token may be a single use payment token, or may have a limit on the number of times it can be used. As another example, the payment token may be associated with an expiration date, an expiration time, etc. In another embodiment, the payment token may be restricted to use with the merchant (e.g., it cannot be used with any other merchant), to a certain dollar amount (e.g., the amount of the funding request), etc. Any other suitable restrictions may be applied to the payment token as is necessary and/or desired.

In step 250, the merchant financial institution backend for the merchant may associate the payment token and bank account and may store the association in, for example, a vault. The merchant financial institution backend may also associate the toke with any restrictions and store that association in, for example, the vault.

In step 255, the merchant financial institution backend for the merchant may provide the payment token to the merchant and may store the payment token in a vault, a user wallet, etc.

In step 260, the merchant may conduct a funding transaction using the payment token. For example, the merchant may conduct an ACH transaction for the funding amount using the payment token.

In step 265, upon receiving the funding transaction, the merchant financial institution backend for the merchant may de-tokenize the payment token by looking up the bank account associated with the payment token in the vault. The merchant financial institution backend may then process the funding transaction.

In embodiments, the merchant financial institution may route the payment to optimize a variable, such as cost, time, etc. For example, the merchant financial institution, the merchant, or the user may provide a preference for a variable to optimize, such as cost, timing, recallability, etc. and the financial institution may route the payment in accordance with the preference. Examples of payment routes may include Automated Clearing House (ACH) payments, Real Time Payments (RTP), credit payments, third-party payments (e.g., Zelle, PayPal, Venmo, etc.).

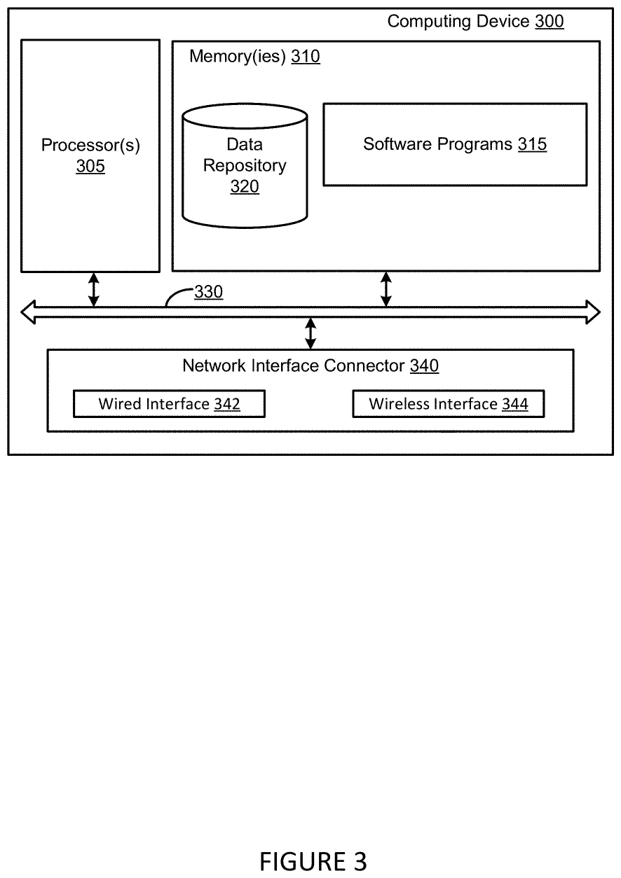

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for integrating pay by bank services, comprising:
receiving, at a merchant computer program for a merchant executed on a user electronic device, a request to add funds to a merchant account or wallet;
receiving, at the merchant computer program, a selection to add an online banking account to the merchant account or wallet;
receiving, at the merchant computer program, a selection of a funding amount;
receiving, at the merchant computer program, a selection of a user financial institution;
receiving, at the merchant computer program, user login credentials for the user financial institution;
receiving, at the merchant computer program and from a user financial institution backend, one or more bank accounts associated with the user login credentials;
receiving, at the merchant computer program, a selection of one of the bank accounts;
receiving, at the merchant computer program, a token for the selected bank account from a merchant financial institution backend;
storing, by the merchant computer program, the token in a merchant wallet; and
conducting, by the merchant computer program, a funding transaction for the funding amount using the token.

2. The method of claim 1, wherein the request to add funds to the merchant account or wallet, the selection to add the online banking account to the merchant account or wallet, the selection of the funding amount, and the selection of the user financial institution are received in a merchant user interface in a browser or application.

3. The method of claim 1, wherein the user login credentials comprise a username and password and/or a token.

4. The method of claim 1, wherein the one or more bank accounts associated with the user login credentials are presented in a lightbox or an iFrame.

5. The method of claim 1, wherein the merchant financial institution backend is configured to generate the token for the selected bank account by generating a unique identifier for the selected bank account, associating the unique identifier with the selected bank account, and storing the association between the unique identifier and the selected bank account.

6. The method of claim 1, wherein the token is limited to use with the merchant.

7. The method of claim 1, wherein the token is restricted to a number of uses.

8. The method of claim 1, wherein the token is restricted to a dollar amount.

9. The method of claim 1, wherein the funding transaction comprises an automated clearing house (ACH) transaction.

10. The method of claim 1, wherein the merchant financial institution backend is configured to optimize a payment route for the funding transaction.

11. A system, comprising:
a user electronic device executing a merchant computer program;
a user financial institution backend executing a user financial institution computer program and in communication with an account database;
a merchant backend for a merchant executing a merchant computer program and in communication with a merchant wallet;
a merchant financial institution backend executing a merchant financial institution computer program and in communication with a vault; and
a payment network;
wherein:
the merchant computer program receives a request to add funds to a merchant account or wallet;
the merchant computer program receives a selection to add an online banking account to the merchant account or wallet;
the merchant computer program receives a selection of a funding amount;
the merchant computer program receives a selection of a user financial institution;
the merchant computer program receives user login credentials for the user financial institution;
the user financial institution computer program authenticates the user using the user login credentials;
the user financial institution computer program retrieves one or more bank accounts associated with the user login credentials and communicates the one or more bank accounts to the merchant computer program;
the merchant computer program receives a selection of one of the bank accounts;
the user financial institution computer program communicates the selected bank account to the merchant financial institution computer program;
the merchant financial institution computer program generates a token comprising a unique identifier for the selected bank account and stores the association in the vault;
the merchant computer program receives the token for the selected bank account from the merchant financial institution computer program;
the merchant computer program stores the token in a merchant wallet; and
the merchant computer program conducts a funding transaction for the funding amount using the token over the payment network.

12. The system of claim 11, wherein the request to add funds to the merchant account or wallet, the selection to add the online banking account to the merchant account or wallet, the selection of the funding amount, and the selection of the user financial institution are received in a merchant user interface in a browser or application.

13. The system of claim 11, wherein the user login credentials comprise a username and password and/or a token.

14. The system of claim 11, wherein the one or more bank accounts associated with the user login credentials are presented in a lightbox or an iFrame.

15. The system of claim 11, wherein the token is limited to use with the merchant.

16. The system of claim 11, wherein the token is restricted to a number of uses.

17. The system of claim 11, wherein the token is restricted to a dollar amount.

18. The system of claim 11, wherein the funding transaction comprises an automated clearing house (ACH) transaction.

19. The system of claim 11, wherein the merchant financial institution backend is configured to optimize a payment route for the funding transaction.

20. A non-transitory computer readable storage medium, including instructions stored thereon, which when read and executed by one or more computer processors, cause the one or more computer processors to perform steps comprising:
receiving a request to add funds to a merchant account or wallet;
receiving a selection to add an online banking account to the merchant account or wallet;
receiving a selection of a funding amount;
receiving a selection of a user financial institution;
receiving user login credentials for the user financial institution;
receiving, from a user financial institution backend, one or more bank accounts associated with the user login credentials;
receiving a selection of one of the bank accounts;
receiving a token for the selected bank account;
storing the token in a merchant wallet; and
conducting a funding transaction for the funding amount using the token.
